(19) United States
(12) Patent Application Publication
(10) Pub. No.: US 2021/0261462 A1
(43) Pub. Date: Aug. 26, 2021

(54) PREPARATION METHOD FOR HIGH-PERFORMANCE WATER INFILTRATION RESISTING MATERIAL

(71) Applicant: Northeastern University, Shenyang, Liaoning (CN)

(72) Inventors: Lianwei YANG, Shenyang, Liaoning (CN); Ruijie WANG, Shenyang, Liaoning (CN)

(21) Appl. No.: 17/056,305

(22) PCT Filed: Dec. 4, 2018
(86) PCT No.: PCT/CN2018/119043

§ 371 Date: Nov. 17, 2020

(30) Foreign Application Priority Data
Nov. 16, 2018 (CN) 201811362926.X

(51) Int. Cl. C04B 28/04; C04B 14/04; C04B 24/42; C04B 14/06; C04B 22/06; C04B 24/26; C04B 22/14; C04B 24/38

(52) U.S. Cl. CPC C04B 28/04; C04B 14/044; C04B 24/425; C04B 14/06; C04B 2111/27; C04B 24/2652; C04B 22/147; C04B 24/38; C04B 22/064

(57) ABSTRACT

The present invention provides a preparation method for a high-performance water infiltration resisting material. Components of the water infiltration resisting material are mixed by the following weight ratio: wherein the content of ammonia silicate is 2.0-7.0 wt %, the content of sodium ethylsiliconate is 1.2-20.5 wt %, the content of polyacrylate-diatomite is 6.0-13.0 wt %, the content of sandy soil is 15.0-40.0 wt %, the content of coarse sand is 4.0-12.0 wt %, the content of calcia is 6.0-17.0 wt %, the content of cement is 30.0-50.0 wt %, and the content of additive is 0.02-0.09 wt %. The present invention can be used in dams, baths, pools, basements, building roofs and other fields of water infiltration resisting, and has the characteristics of high resistance to water infiltration, long effective water resistance time, being non-toxic and harmless, and convenient use.

### TECHNICAL FIELD

The present invention belongs to the field of water infiltration resisting material preparation, and relates to a preparation method for a high-performance water infiltration resisting material, which is used in dams, baths, pools, basements, building roofs and other fields of water resisting, and can also be used for improving lean soil that does not retain water. cl BACKGROUND

A water infiltration resisting material is a very important material, which plays an important role in roofs, highways, airports, reservoir dams, bathrooms, kitchens, tunnels, swimming pools and other fields. The quality of the water infiltration resisting material is directly related to the quality of project construction. With the continuous improvement of social living conditions, people have higher and higher requirements for water infiltration resisting materials. With the rapid development of science and technology, water resisting materials have experienced the development process of asphalt, polyurethane resin, polyacrylic acid and polyacrylamide polymer, and inorganic permeable salts. Among them, asphalt and polyurethane resin water resisting materials have been prohibited by explicit orders by the state because of serious pollution and toxicity; acrylic acid and acrylamide polymer water resisting materials have poor durability, are easy to age, and have a short service life; in addition, once a water resisting film layer is damaged, leakage will occur immediately. Patent CN201810116545.7 discloses a waterproof material for building construction and a preparation method therefor, which uses the raw materials such as epoxy resin, polyurethane resin, quartz sand, asphalt, zirconium dioxide; although the waterproof material for building construction has a certain waterproof effect, the service life is not long. Patent CN1800291 discloses a leak-stopping waterproof material which is composed by weight percentage of 24%-60% of Portland cement, 20%-63% of high-aluminum clinker, 0%-10% of potassium aluminum sulfate dodecahydrate, 1%-5% of dihydrate gypsum, 0%-1% of sodium polyacrylate, 2%-10% of bentonite, 0%-2% of emulsion powder and 10%-20% of quartz sand; although the leak-stopping waterproof material has a certain effect of slowing down water infiltration in a short period of time, water can still infiltrate after a long-term use. Patent CN108359292A discloses a preparation method for a cement-based waterproof material, which uses water, ethanol, silane coupling agent, sodium bentonite abrasive and sodium hydroxide as raw materials; the cement-based waterproof material is not only complicated in process, but also has an unsatisfactory waterproof effect.

### SUMMARY

In view of the defects of the prior art, the present invention provides a preparation method for a high-performance water infiltration resisting material which is composed of sodium ethylsiliconate, polyacrylate-diatomite and other materials, and has good water infiltration resisting effect. After being mixed with water in a certain proportion, the high-performance water infiltration resisting material is filled in a leak or spread on the surface of an object that need to be waterproof

The present invention has the following specific technical solution:

A preparation method for a high-performance water infiltration resisting material, wherein components of the water infiltration resisting material are mixed by the following weight ratio:

| | |
|---|---|
| ammonia silicate | 2.0-7.0 wt % |
| sodium ethylsiliconate | 1.2-20.5 wt % |
| polyacrylate-diatomite | 6.0-13.0 wt % |
| sandy soil | 15.0-60.0 wt % |
| coarse sand | 4.0-12.0 wt % |
| calcia | 1.0-7.0 wt % |
| cement | 30.0-50.0 wt % |
| additive | 0.02-0.09 wt %; |

and the additive is a mixture of methylene bisacrylamide, sodium persulfate and sodium alginate prepared by a mass ratio of 1:3:6.

Further, the polyacrylate-diatomite means that the weight percentage of diatomite is 60%-90%, and the rest is polyacrylate; and the polyacrylate is one or more of sodium polyacrylate, potassium polyacrylate or ammonia polyacrylate.

Further, the particle size of the sandy soil is 100-150 meshes.

Further, the particle size of the coarse sand is 10-50 meshes.

Further, the particle size of the calcia is 100 meshes.

Further, the cement is ordinary Portland cement or aluminate cement.

An application of the high-performance water infiltration resisting material prepared by the method mentioned above, wherein during construction, the high-performance water infiltration resisting material is mixed with water by a mass ratio of 2:1, stirred evenly and filled in a leak or spread on the surface of an object that need to be waterproof, such as a roof, and the spreading thickness is 2-8 cm.

The present invention has the following beneficial effects: the water infiltration resisting material prepared by the method is easy to absorb water, and quickly expands to fill the leak after absorbing water; in addition, a hydrophobic layer can be formed both on a surface and inside a material that need to be waterproof to prevent water infiltration and play a double sealing and water resisting role; therefore, the water infiltration resisting material prepared by the method can effectively prevent water infiltration or permeation. The present invention can be used in dams, baths, pools, basements, building roofs and other fields of water infiltration resisting, and has the characteristics of high resistance to water infiltration, long effective water resistance time, being non-toxic and harmless, and convenient use.

### DETAILED DESCRIPTION

### Embodiment 1

The high-performance water infiltration resisting material can be prepared by adding 1 kg of ammonia silicate and 6 kg of sodium ethylsiliconate to a container, adding 1 kg of water, and stirring well to make mix evenly first; then adding 10 kg of sodium polyacrylate-diatomite, 26 kg of 100-mesh sandy soil, 6 kg of 10-mesh coarse sand, 1 kg of calcia, 49 kg of Portland cement and 0.03 kg of additive in sequence, and stirring well to make mix well. During construction, the water infiltration resisting material is mixed with water (the mass ratio of the water infiltration resisting material to the water is 2:1), stirred evenly and spread on a roof or ground with a thickness of 2-8 cm.

### Embodiment 2

The high-performance water infiltration resisting material can be prepared by adding 3 kg of ammonia silicate and 5 kg of sodium ethylsiliconate to a container, adding 1 kg of water, and stirring well to make mix evenly first; then adding 8 kg of sodium polyacrylate-diatomite, 30 kg of 120-mesh sandy soil, 4 kg of 20-mesh coarse sand, 2 kg of calcia, 47 kg of Portland cement and 0.05 kg of additive in sequence, and stirring well to make mix well. During construction, the water infiltration resisting material is mixed with water (the mass ratio of the water infiltration resisting material to the water is 2:1), stirred evenly and spread on a roof or ground with a thickness of 2-8 cm.

### Embodiment 3

The high-performance water infiltration resisting material can be prepared by adding 5 kg of ammonia silicate and 4 kg of sodium ethylsiliconate to a container, adding 1 kg of water, and stirring well to make mix evenly first; then adding 6 kg of sodium polyacrylate-diatomite, 30 kg of 150-mesh sandy soil, 7 kg of 40-mesh coarse sand, 3 kg of calcia, 44 kg of Portland cement and 0.08 kg of additive in sequence, and stirring well to make mix well. During construction, the water infiltration resisting material is mixed with water (the mass ratio of the water infiltration resisting material to the water is 2:1), stirred evenly and spread on a roof or ground with a thickness of 2-8 cm.

### Embodiment 4

The high-performance water infiltration resisting material can be prepared by adding 6 kg of ammonia silicate and 9 kg of sodium ethylsiliconate to a container, adding 1 kg of water, and stirring well to make mix evenly first; then adding 12 kg of sodium polyacrylate-diatomite, 15 kg of 100-mesh sandy soil, 7 kg of 50-mesh coarse sand, 5 kg of calcia, 45 kg of Portland cement and 0.09 kg of additive in sequence, and stirring well to make mix well. During construction, the water infiltration resisting material is mixed with water (the mass ratio of the water infiltration resisting material to the water is 2:1), stirred evenly and spread on a roof or ground with a thickness of 2-8 cm.

### Embodiment 5

The high-performance water infiltration resisting material can be prepared by adding 1 kg of ammonia silicate and 6 kg of sodium ethylsiliconate to a container, adding 1 kg of water, and stirring well to make mix evenly first; then adding 10 kg of sodium polyacrylate-diatomite (the weight percentage of diatomite is 60%), 26 kg of 100-mesh sandy soil, 6 kg of 10-mesh coarse sand, 1 kg of calcia, 49 kg of Portland cement and 0.03 kg of additive in sequence, and stirring well to make mix well. During construction, the water infiltration resisting material is mixed with water (the mass ratio of the water infiltration resisting material to the water is 2:1), stirred evenly and spread on a roof or ground with a thickness of 2-8 cm.

### Embodiment 6

The high-performance water infiltration resisting material can be prepared by adding 3 kg of ammonia silicate and 5 kg of sodium ethylsiliconate to a container, adding 1 kg of water, and stirring well to make mix evenly first; then adding 8 kg of sodium polyacrylate-diatomite (the weight percentage of diatomite is 70%), 30 kg of 120-mesh sandy soil, 4 kg of 20-mesh coarse sand, 2 kg of calcia, 47 kg of Portland cement and 0.05 kg of additive in sequence, and stirring well to make mix well. During construction, the water infiltration resisting material is mixed with water (the mass ratio of the water infiltration resisting material to the water is 2:1), stirred evenly and spread on a roof or ground with a thickness of 2-8 cm.

### Embodiment 7

The high-performance water infiltration resisting material can be prepared by adding 5 kg of ammonia silicate and 4 kg of sodium ethylsiliconate to a container, adding 1 kg of water, and stirring well to make mix evenly first; then adding 6 kg of sodium polyacrylate-diatomite (the weight percentage of diatomite is 80%), 30 kg of 150-mesh sandy soil, 7 kg of 40-mesh coarse sand, 3 kg of calcia, 44 kg of Portland cement and 0.08 kg of additive in sequence, and stirring well to make mix well. During construction, the water infiltration resisting material is mixed with water (the mass ratio of the water infiltration resisting material to the water is 2:1), stirred evenly and spread on a roof or ground with a thickness of 2-8 cm.

### Embodiment 8

The high-performance water infiltration resisting material can be prepared by adding 6 kg of ammonia silicate and 9 kg of sodium ethylsiliconate to a container, adding 1 kg of water, and stirring well to make mix evenly first; then adding 12 kg of sodium polyacrylate-diatomite (the weight percentage of diatomite is 90%), 15 kg of 100-mesh sandy soil, 7 kg of 50-mesh coarse sand, 5 kg of calcia, 45 kg of Portland cement and 0.09 kg of additive in sequence, and stirring well to make mix well. During construction, the water infiltration resisting material is mixed with water (the mass ratio of the water infiltration resisting material to the water is 2:1), stirred evenly and spread on a roof or ground with a thickness of 2-8 cm.

1. A preparation method for a high-performance water infiltration resisting material, wherein components of the water infiltration resisting material are mixed by the following weight ratio:

| | |
|---|---|
| ammonia silicate | 2.0-7.0 wt % |
| sodium ethylsiliconate | 1.2-20.5 wt % |
| polyacrylate-diatomite | 6.0-13.0 wt % |
| sandy soil | 15.0-60.0 wt % |
| coarse sand | 4.0-12.0 wt % |
| calcia | 1.0-7.0 wt % |
| cement | 30.0-50.0 wt % |
| additive | 0.02-0.09 wt %; |

and the additive is a mixture of methylene bisacrylamide, sodium persulfate and sodium alginate prepared by a mass ratio of 1:3:6,
the polyacrylate-diatomite means that the weight percentage of diatomite is 60%-90%, and the rest is polyacrylate; and the polyacrylate is one or more of sodium polyacrylate, potassium polyacrylate or ammonia polyacrylate.

2. (canceled)

3. The preparation method for the high-performance water infiltration resisting material according to claim 1, wherein the particle size of the sandy soil is 100-150 meshes.

4. The preparation method for the high-performance water infiltration resisting material according to claim 1, wherein the particle size of the coarse sand is 10-50 meshes.

5. The preparation method for the high-performance water infiltration resisting material according to claim 1, wherein the particle size of the calcia is 100 meshes.

6. The preparation method for the high-performance water infiltration resisting material according to claim 1, wherein the cement is ordinary Portland cement or aluminate cement.

7. An application of the high-performance water infiltration resisting material prepared by the method of claim 1, wherein during construction, the high-performance water infiltration resisting material is mixed with water by a mass ratio of 2:1, stirred evenly and spread on a roof or ground with a thickness of 2-8 cm.

8. The preparation method for the high-performance water infiltration resisting material according to claim 1, wherein the polyacrylate-diatomite means that the weight percentage of diatomite is 70%, and the rest is polyacrylate; and the polyacrylate is sodium polyacrylate.
